(19) United States
(12) Patent Application Publication
(10) Pub. No.: US 2012/0137690 A1
(43) Pub. Date: Jun. 7, 2012

(54) WIDE FREQUENCY RESPONSE TUNABLE RESONATOR

(75) Inventor: Swanand Vijay Sardeshmukh, West Lafayette, IN (US)

(73) Assignee: General Electric Company, Schenectady, NY (US)

(21) Appl. No.: 12/960,422

(22) Filed: Dec. 3, 2010

(51) Int. Cl. F02C 7/24

(52) U.S. Cl. 60/725

(57) ABSTRACT

A system includes a resonator controller. The resonator controller may adjust a ratio of a first fluid and a second fluid into a resonator, whereby the first fluid is different than the second fluid. Additionally, the resonator controller may control a resonance frequency of the resonator to dampen oscillations based on the ratio.

### BACKGROUND OF THE INVENTION

The subject matter disclosed herein relates to dampening of acoustic oscillations in a fuel nozzle.

A gas turbine engine combusts a mixture of fuel and air to generate hot combustion gases, which in turn drive one or more turbine stages. In particular, the hot combustion gases force turbine blades to rotate, thereby driving a shaft to rotate one or more loads, e.g., electrical generator. Unfortunately, certain parameters may induce or increase pressure oscillations in the combustion process, thereby reducing part life, performance and efficiency of the gas turbine engine. For example, the pressure oscillations may be at least partially attributed to fluctuations in fuel pressure or air pressure directed into a combustor. These fluctuations may drive combustor pressure oscillations at various frequencies, which may be particularly detrimental to the performance and life of the gas turbine engine. For example, high pressure fluctuations may lead to fatigue of one or more parts in the gas turbine engine, causing the one or more parts to fail earlier than if those fluctuations were not present. Accordingly, it may be beneficial to reduce the oscillations (or fluctuations) generated in the gas turbine engine.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a resonator configured to dampen oscillations and a resonator control system configured to provide a ratio of a first fluid and a second fluid into the resonator to control a resonance characteristic of the resonator, wherein the first fluid is different than the second fluid.

In a second embodiment, a system includes a resonator controller configured to adjust a ratio of a first fluid and a second fluid into a resonator, the first fluid is different than the second fluid, and the resonator controller is configured to control a resonance frequency of the resonator to dampen oscillations based on the ratio.

In a third embodiment, a system includes an engine comprising a combustion chamber and a resonator coupled to the combustion chamber, wherein the resontator is configured to dampen oscillations in the combustion chamber, the resontator is configured to receive a first fluid and a second fluid in a ratio to control a resonance frequency of the resonator, and the first fluid is different than the second fluid.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a turbine system having a control system coupled to a combustor in accordance with an embodiment of the present technique;

FIG. 2 is a cross-sectional side view of a resonator in conjunction with the control system, as illustrated in FIG. 1, in accordance with an embodiment of the present technique;

FIG. 3 is a graph illustrating resonator capability with multiple working fluids, in accordance with an embodiment of the present technique; and

FIG. 4 illustrates a side view of a second control system coupled to a combustor in accordance with an embodiment of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure may reduce combustion driven oscillations by dampening pressure fluctuations within fluid supplies (e.g., liquid and/or gas lines) and/or dampen combustion generated acoustic oscillations via one or more resonators. In certain embodiments, the one or more resonators may be located in close proximity to the oscillations to maximize the dampening effect. For example, the resonator(s) may be placed directly in the body of the fuel nozzle, e.g. in the middle and/or tip of the fuel nozzle, in a manifold upstream of the fuel nozzle, and/or downstream of the fuel nozzle.

Additionally, the resonator(s) may be tuned to dampen oscillations of a certain frequency or may be tuned to operate as a wide band frequency dampener. In certain embodiments, each resonator may be tuned by changing a fluid in the resonator, thereby changing the sonic speed and resonant frequency of the resonator. For example, each resonator may be tuned by varying amounts (e.g., a ratio) of two or more fluids provided to the resonator. Any suitable number and type of fluids may be used to tune the resonator. In one embodiment, each resonator may be tuned by varying amounts (e.g., a ratio) of steam and carbon dioxide (CO2) provided to the resonator. Control of the fluids transmitted to the resonator(s) may be governed via a controller. The controller may receive information relating to the frequencies of oscillations in a combustor from at least one sensor and may tune the resonator(s) to dampen the current oscillations being produced by adjusting the ratio of the first fluid and the second fluid provided to the resonator(s). That is, the controller may be communicatively coupled to the resonator(s), and may tune the resonator(s) to frequencies detected by the at least one sensor. The resonator(s) may include Helmholtz resonators and/or quarter wave resonators, among others.

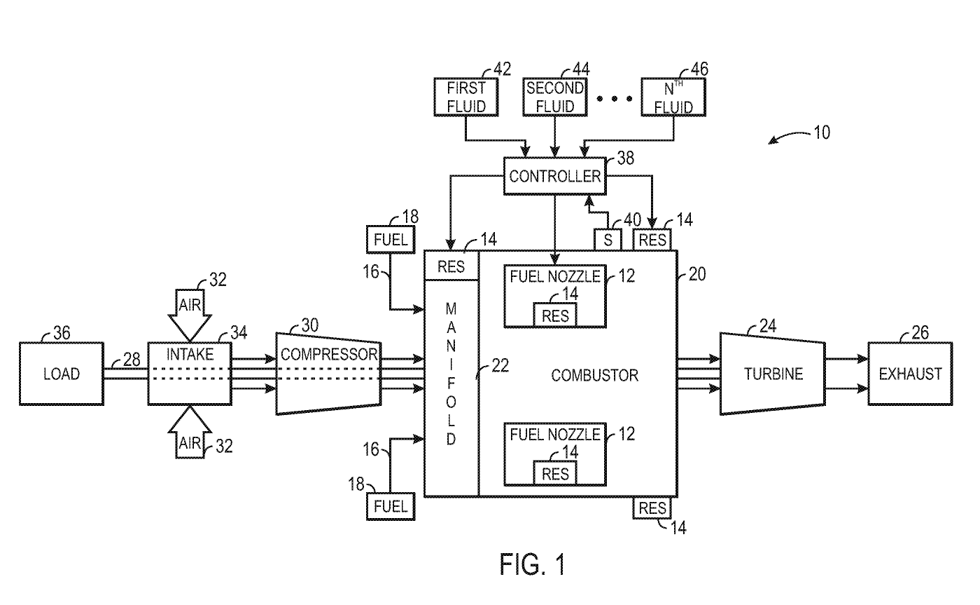

Turning now to the drawings and referring first to FIG. 1, an embodiment of a turbine system 10 may include one or more fuel nozzles 12. Although acoustic oscillations may be generated during combustion of fuel from the fuel nozzles 12, the disclosed embodiments of the fuel nozzles 12 may include resonators 14 integral to the fuel nozzles 12 to dampen the generated acoustic oscillations. Additionally and/or alternatively, at least one resonator 14 may be positioned upstream and/or downstream of the fuel nozzles 12 to aid in dampening of the acoustic oscillations generated during combustion of fuel from the fuel nozzles 12.

The turbine system, (e.g., gas turbine engine), 10 may use liquid or gas fuel, such as natural gas and/or a hydrogen rich synthesis gas, to run the turbine system 10. As depicted, the fuel nozzles 12 intake a fuel stream 16 via fuel supply 18 to inject fuel into combustor 20. This fuel stream 16 may pass through a through, for example, a manifold 22. In one embodiment, the manifold 22 may be internal to or coupled to the combustor 20 and may operate as a junction that allows a plurality of fluids to be transmitted into the combustor 20.

Additionally, air may be injected into combustor 20, for example, through the manifold 22, to mix with the fuel injected into the combustor 20 by the fuel nozzle 12 to generate a fuel-air mixture. This fuel-air mixture may be ignited in the combustor 20. The combustion of this fuel-air mixture in the combustor 20 creates hot, pressurized exhaust gases. The combustor 20 passes the hot pressurized exhaust gas into a turbine 24. That is, the combustor 10 directs the exhaust gases through a turbine 24 toward an exhaust outlet 26. The exhaust gas passes through at least one turbine stage (e.g., turbine blades) in the turbine 24, thereby driving the turbine 24 to rotate. In turn, a coupling between the blades in the turbine 24 and a shaft 28 will cause the rotation of the shaft 28, which is also coupled to several components throughout turbine system 10.

As illustrated, the shaft 28 may be connected to various components of the turbine system 10, including a compressor 30. The compressor 30 also includes blades that may be coupled to the shaft 28. As the shaft 28 rotates, the blades within the compressor 30 may also rotate, thereby compressing air 32 from an air intake 34 through the compressor 30 and into the fuel nozzles 12 and/or the combustor 20. The shaft 28 may also be connected to a load 36, which may be powered via rotation of the shaft 28. As appreciated, the load 36 may be any suitable device that may generate power via the rotational output of turbine system 10, such as a power generation plant or an external mechanical load. For example, load 30 may include an electrical generator, a propeller of an airplane, and so forth.

The resonators 14 of the turbine system 10 may have a resonant frequency (F) defined by the following equation:

F=(c/2π)√(S/VL)

where c=sonic speed, S=area of resonator 14 holes, V=resonator 14 volume, and L=neck length of resonator 14 holes. In one embodiment, the sonic speed c of the resonators 14 may be changed to modify the overall response (e.g., acoustic dampening) of the resonators 14. For example, in a gaseous medium, sonic speed c is dependent on the temperature, the molecular structure, and the molecular weight of the gaseous medium. Thus, by introducing and varying the amount of at least two or more gaseous mediums with differing molecular structures and molecular weights transmitted to the resonators 14, a wider array of frequencies may be dampened via the resonators 14.

The turbine system 10 includes a controller 38, which may be an electric or electronic device for controlling fluid flow to the resonator(s) 14. In the present embodiment, the controller 38 may be communicatively coupled to each resonator 14 and at least one sensor 40, which may be in fluid communication with the combustor 20. In one embodiment, the sensor 40 may be a pressure sensor. However, the sensor 40 may include any suitable sensor obtaining feedback indicative of pressure oscillations and/or combustion dynamics. For example, the sensor 40 may include a temperature sensor, a flame sensor, or a vibration sensor. The controller 38 may receive information from the sensor 40 relating to the detected frequency of pressure oscillations within, for example, the combustor 20. Additionally, one or more sensors 40 may be placed in proximity to the manifold 22 or the fuel nozzles 12 to detect pressure oscillations therein.

Based on this information received from the sensor 40, the controller 38 may tune the resonator(s) 14 to match the detected frequency by adjusting the ratio of fluids provided to the resonator(s) 14. These fluids may include a first fluid 42, a second fluid 44, and so forth up to an Nth fluid 46. Examples of fluids for use as the fluids 42, 44, and 46 may include, but are not limited to, water (e.g., in the form of steam), carbon dioxide, nitrogen, air, and/or other fluids. The fluids 42, 44, and 46 may each have differing molecular weights, may include monatomic and polyatomic fluids, and/or may have differing specific heat ratios from one another. For example, a molecular weight or a specific heat ratio of the first fluid 42 may be at least greater than approximately 5 percent, 10 percent, 15 percent, 20 percent, 30 percent, 40 percent, 50 percent or more different than the second fluid 44.

By adjusting the ratio of fluids, such as the first fluid 42 and the second fluid 44, provided to the resonator(s) 14, the overall frequencies that may be dampened by the resonator(s) 14 may be broadened to include a wider array of frequencies. Furthermore, more specific tuning of the resonator(s) 14 may be accomplished through control of the fluids, e.g. first fluid 42 and second fluid 44, provided to the resonator(s) 14 by choosing combinations of the fluids 42 and 44 that are tuned to acoustically dampen a detected oscillation frequency. This may result in the reduction of the magnitude of specific pressure oscillations within the combustor 20.

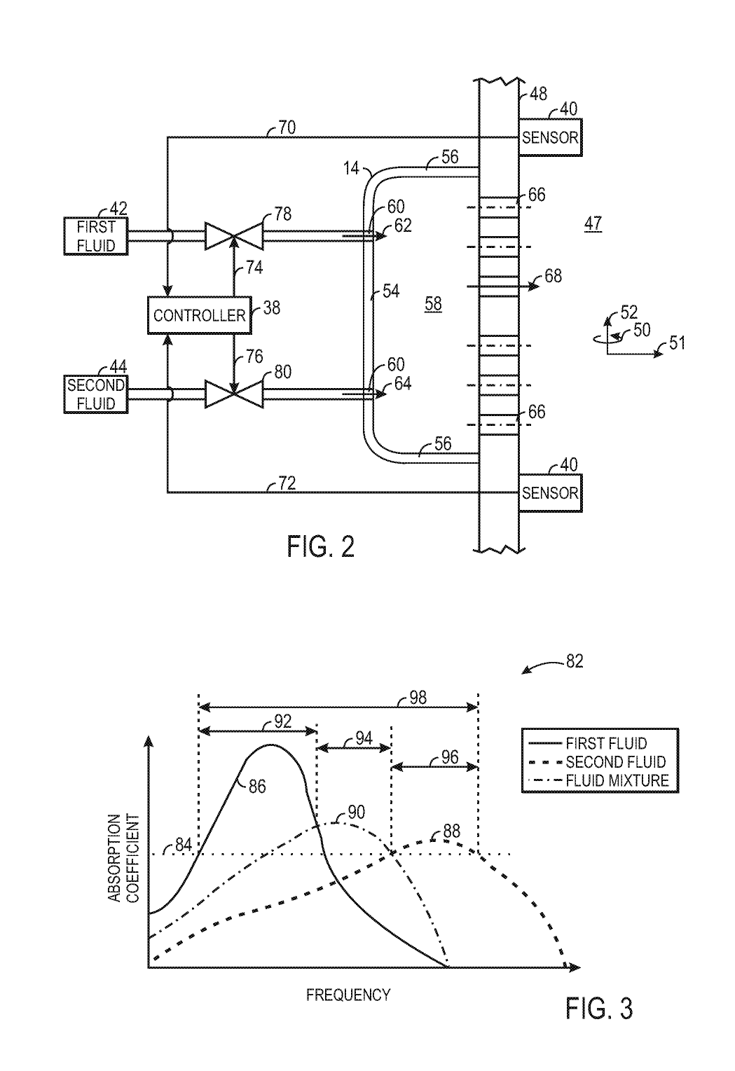

FIG. 2 is a schematic of an embodiment of the resonator 14 that may be located axially downstream of the fuel nozzles 12 of FIG. 1. In the illustrated embodiment, the resonator 14 is disposed axially upstream of a combustion chamber 47 of the combustor 20. It should be noted that various aspects of the operation of the resonator 14 may be described with reference to a circumferential direction or axis 50, a radial direction or axis 51, and an axial direction or axis 52. For example, the axis 50 corresponds to the circumferential direction about the longitudinal centerline of the combustor 20, the axis 51 corresponds to a crosswise or radial direction relative to the longitudinal centerline, and the axis 52 corresponds to a longitudinal centerline or lengthwise direction along the combustor 20. Thus, in the illustrated embodiment, the resonator 14 may be an annular chamber surrounding the combustion chamber 47 of the combustor 20 in the circumferential direction 50. That is, the resonator 14 may be coupled to and encircle the outer wall 48 of the combustor 20, which surrounds the combustion chamber 47. In another embodiment, the resonator 14 may be disposed in an interior of the combustor 20, such that an upstream plate 54 of the resonator extends in the radial direction 51 from the outer wall 48 across the interior of the combustor 20 axially upstream from the combustion chamber 47. For example, the resonator 14 may be disposed along a downstream end portion of the fuel nozzles 12. In either embodiment, the resonator 14 is configured to dampen pressure oscillations occurring from, for example, combustion dynamics in the combustor 20.

The resonator 14 may operate to dampen the acoustic oscillations caused by the combustion process, which may be influenced by air and fuel pressure fluctuations transmitted to the nozzles 12. In this manner, fluctuations at particular frequencies, which would otherwise reduce performance and life of the turbine system 10 by oscillating at one or more natural frequencies of a part or subsystem within the turbine system 10, may be attenuated or even eliminated. The acoustic oscillations may be largest immediately downstream of the nozzles 12. Accordingly, it may be beneficial to place the acoustic resonator 14 adjacent to the downstream portion of the fuel nozzle 12, so as to bring it into close proximity with the location of the pressure oscillations in the combustion chamber 47.

The resonator 14 may include an upstream plate 54 and at least one side plate 56 that may be joined with the upstream plate 54 and the outer wall 48 to form a resonator cavity 58. The upstream plate 54 may radially 52 extend parallel to the outer wall 48 and may be, for example, approximately 0.2, 0.4, 0.6, 0.8, 1.0, 1.2, 1.4, 1.6, 1.8, or 2.0 inches wide. The side plate 56 may axially 51 extend from the outer wall 48 to the upstream plate 54 at a distance of, for example, approximately 0.5, 1, 1.5, 2, 2.5, or 3 inches. Thus the outer wall 48 and the upstream plate 54 may be parallel, while the side plate(s) 56 extend laterally about a perimeter of the cavity 58. Furthermore, in certain embodiments, the upstream plate 54 may be disc shaped, the side plate(s) 56 may be annular shaped, and/or the cavity 58 may be cylindrical.

Fluids, such as the first fluid 42 and the second fluid 44, may enter the resonator cavity 58 via one or more fluid inlets 60, which may be axially 51 disposed through the upstream plate 54 of the resonator 14. The fluid inlets 60 may be, for example, approximately 0.01, 0.03, 0.05, 0.1, 0.15, or 0.20 inches in diameter. The fluid inlets 60 may allow for fluid to pass axially 51 into the resonator cavity 58 along directional lines 62 and 64. The fluids, e.g., first fluid 42 and second fluid 44, may further axially 51 pass into the combustion chamber 47 through fluid outlet ports 66, as indicated by directional line 68. That is, the fluid outlet ports 66 directly expel fluid into the combustion zone of the combustion chamber 47. The fluid outlet ports 66 may be, for example, approximately 0.05, 0.1, 0.15, 0.2, 0.25, or 0.3 inches in diameter.

Accordingly, the resonator 14 includes the resonator cavity 58 to dampen pressure oscillations (e.g., air, fuel, combustion, etc.) while also flowing one or more fluids, e.g., fluids 42 and 44, directly into the combustion chamber 47 via fluid outlet ports 66 adjacent, for example, the downstream end of the fuel nozzle 12. For example, due to air 32 and fuel 18 pressure fluctuations (e.g., oscillations), an uneven fuel/air mixture may be transmitted into the combustor 20. As this fuel/air mixture is combusted, fluid, such as exhaust gases, may be forced into the cavity 58 via fuel outlet ports 66, thus increasing the pressure inside of the cavity 58, while simultaneously reducing the oscillations in the combustion chamber 47. In this manner, the pressure oscillations may not form acoustic pressure waves. When the pressure oscillations are no longer being generated, (e.g., the fuel/air mixture variation lessens), the elevated pressure in the cavity 58 will force exhaust gases, along with fluids 42 and 44, back through the fuel outlet ports 66 to equalize the pressure in the cavity 58 with the pressure of the combustion zone 47. This process may be repeated such that the dampening may cause the pressure oscillations to lessen, thus causing fewer or no acoustic oscillations to be generated. In this manner, the resonator 14 may dissipate the energy of the pressure oscillations caused by the combustion of a fluctuating fuel/air mixture.

Furthermore, this process may be optimized by tuning the resonator 14, that is, by matching the resonance frequency of the resonator 14 to the oscillations produced in the combustion chamber 47. These oscillations may be measured via one or more sensors 40, which may be pressure sensors in fluid communication with the combustion chamber 47. These measurements relating to detected frequency of pressure oscillations within the combustion chamber 47 may be transmitted to the controller 38 along paths 70 and 72. Based on the measurements received from the sensors 40, the controller 38 may tune the resonator 14 to match the detected frequency by adjusting the ratio of fluids, e.g., fluids 42 and 44, provided to the resonator 14. The adjustment of the ratio of fluid 42 relative to fluid 44 may be adjusted by the controller 38 by transmitting one or more control signals along paths 74 and 76 to valves 78 and 80. These control signals transmitted along paths 74 and 76 may control the opening and closing of the valves 78 and 80. By adjusting the opening and closing of valves 78 and 80, the amount of first fluid 42 transmitted along directional line 62 and the amount of second fluid 44 transmitted along directional line 64 into the resonator cavity 58 may be controlled.

Furthermore, by adjusting the ratio of fluids, such as the first fluid 42 and the second fluid 44, provided to the resonator 14, the overall frequencies that may be dampened by the resonator 14 may be broadened to include a wider array of frequencies in addition to more specific tuning of the resonator 14 through control of the fluids, e.g. first fluid 42 and second fluid 44. That is, by varying the ratio of fluids 42 and 44 provided to the cavity 58, the amount of fluid, such as exhaust gases, able to enter the cavity 58 via fuel outlet ports 66 to increase the pressure inside of the cavity 58 changes. That is, the amount of exhaust gas that may enter the resonator cavity 58 at any given time may be related to the ratio of first fluid 42 to second fluid 44 in the resonator cavity 58 at that time. Furthermore, the amount of exhaust gas that enters the resonator cavity 58 at any given time controls the frequencies dampened by the resonator 14, since the frequencies dampened by the resonator 14 may change in relation to the amount of exhaust gas that may enter and exit the fluid outlet ports 66 to equalize the pressure in the cavity 58 with the pressure of the combustion zone 47.

As discussed above, tuning of the resonator 14 may be responsive to the pressure oscillations generated in the combustion chamber 47. These pressure oscillations may change depending on a number of factors, such as the fuel to be combusted (e.g., synthetic natural gas, substitute natural gas, natural gas, hydrogen, etc.), the number fuel nozzles 12, the size of the combustion zone, the rate at which a fuel/air mixture enters the combustion zone 47, as well as other factors. Based on these factors, the fluids, e.g., first fluid 42 and second fluid 44, introduced into the resonator cavity 58 to counteract the oscillations generated in a given combustion zone 47 may be actively controlled via the controller 38.

FIG. 3 is a graph 82 illustrating frequency versus absorption coefficient (the resonator 14 response) for a resonator 14 that may receive an adjustable amount of a first fluid 42 and a second fluid 44. As illustrated in the graph 82, a minimum absorption coefficient level 84 may exist whereby absorption of oscillations by the resonator 14 at levels greater than the minimum absorption coefficient level 84 sufficiently reduces the oscillations in the combustion chamber 47. Conversely, absorption of oscillations at levels lower than the minimum absorption coefficient level 84 may not sufficiently reduce the oscillations in the combustion chamber 47 to impact, for example, overall part life of components of the combustor in a meaningful manner. Accordingly, the controller 38 may operate in conjunction with the valves 78 and 80 to regulate the flow of the first fluid 42 and the second fluid 44 into the resonator cavity 58 to insure that the resonator 14 operates at least at the minimum absorption coefficient level 84.

For example, graph 82 illustrates three curves 86, 88, and 90, where curve 86 corresponds to the absorption of the resonator 14 if only a first fluid 42 is transmitted to the resonator 14. Similarly, curve 88 corresponds to the absorption of the resonator 14 if only a second fluid 42 is transmitted to the resonator 14. Finally, curve 90 corresponds to the absorption of the resonator 14 if a fluid mixture 92 of the first fluid 42 and the second fluid 44 is transmitted to the resonator 14. As illustrated, curve 86 illustrates a range of frequencies 92 over which transmission of only the first fluid 42 may be transmitted to the resonator 14 to insure that the resonator 14 sufficiently dampens oscillations in the combustion chamber 47 (e.g., above the minimum absorption coefficient level 84). Similarly, curve 90 illustrates a range of frequencies 94 over which transmission of the fluid mixture 92 may be transmitted to the resonator 14 to insure that the resonator 14 sufficiently dampens oscillations in the combustion chamber 47. Finally, curve 88 illustrates a range of frequencies 96 over which transmission of only the second fluid 44 may be transmitted to the resonator 14 to insure that the resonator 14 sufficiently dampens oscillations in the combustion chamber 47.

Accordingly, the entire range of frequencies 98 over which the resonator 14 may sufficiently dampen oscillations in the combustion chamber 47 (e.g., above the minimum absorption coefficient level 84), may be extended relative to utilization of only the first fluid 42 or only the second fluid 44. In one embodiment, the entire range of frequencies 98 over which the resonator 14 may sufficiently dampen oscillations in the combustion chamber 47 may be, for example, approximately 2000 Hz, 2100 Hz, 2200 Hz, 2300 Hz, 2400 Hz, 2500 Hz, 2600 Hz, 2700 Hz, 2800 Hz, 2900 Hz, 3000 Hz, or greater. Moreover, while the combination of the first fluid 42 and the second fluid 44 are illustrated in FIG. 3, as previously noted, it is contemplated that more than two fluids may be combined in the resonator 14 to change the overall absorption characteristics of the resonator 14. For example, the disclosed resonator 14 may receive any combination of 1 to 5, 1 to 10, or 1 to 20 fluids to broaden the frequency response of the resonator 14.

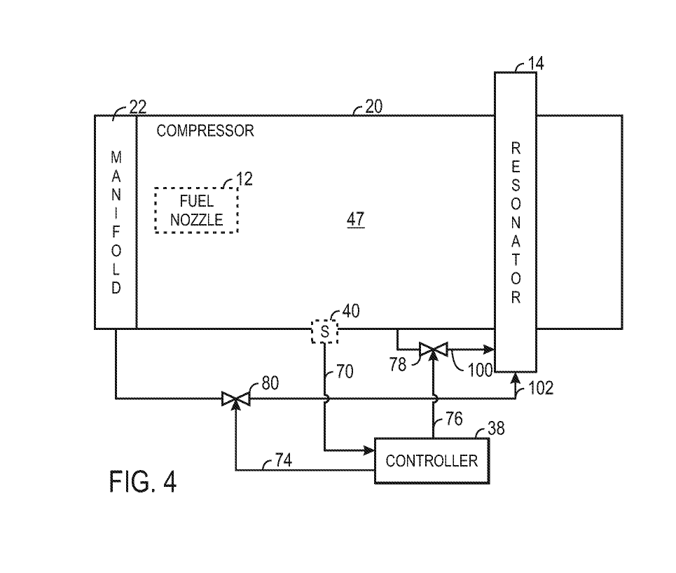

FIG. 4 illustrates a side view of a combustor 20 in conjunction with an embodiment of the present technique. The combustor 20 may include a fuel nozzle 12 and a combustion chamber 47 downstream of the nozzle 12. The combustor 20 may also be coupled to a manifold 22 and a resonator 14. In one embodiment, the manifold may operate as a heat exchanger that utilizes water to cool fluids passing through the manifold 22. This water may absorb heat from fluids passing through the manifold 22 and may become steam vapor, which, as will be discussed in greater detail below, may be utilized as a fluid, e.g., second fluid 44, in conjunction with the resonator 14.

As noted above, the combustor 20 may be coupled to a resonator 14. The resonator 14 may be an annular chamber surrounding the combustion chamber 47. A sensor 40 may also be fluidly connected to the combustion chamber 47. Moreover, a controller 38 may be proximate to the combustor 20 and may be coupled to the sensor 40 via path 70 to receive information relating to the detected frequency of pressure oscillations within the combustion chamber 47.

The controller 38 may also be coupled to a valve 78 that regulates the amount of carbon dioxide (with a molecular weight of approximately 44 grams per mole) transmitted to the resonator 14 along path 100 and a valve 80 that regulates the amount of water (e.g., steam with a molecular weight of approximately 18 grams per mole) transmitted to the resonator 14 along path 102. Thus, the controller 38 may utilize fluids (e.g., steam and carbon dioxide) already present in operation of the combustor 20 as fluids to be mixed to adaptively insure that a minimum absorption coefficient level 84 in the resonator 14 is maintained. That is, measurements relating to detected frequency of pressure oscillations within the combustion chamber 47 may be transmitted to the controller 38 along path 70, and based on the measurements received from the sensor 40, the controller 38 may tune the resonator 14 either to match the detected frequency by adjusting the ratio of the steam and carbon dioxide provided to the resonator 14 or may tune the resonator 14 to insure that the minimum absorption coefficient level 84 in the resonator 14 is maintained. The adjustment of the ratio of steam to carbon dioxide may be accomplished by transmitting one or more control signals along paths 74 and 76 to control the opening and closing of valves 78 and 80. By adjusting the opening and closing of valves 78 and 80, the amount of carbon dioxide transmitted to the resonator 14 along path 100 and the amount of steam transmitted along path 102 into the resonator 14 may be controlled.

By adjusting the ratio of fluids, such as the first fluid 42 and the second fluid 44, provided to the resonator 14, the overall frequencies that may be dampened by the resonator 14 may be broadened to include a wider array of frequencies. Additionally, adjustment of the ratio of fluids, such as the first fluid 42 and the second fluid 44, provided to the resonator 14 may allow for tuning the resonator 14 to dampen a specified frequency. In one embodiment, these adjustments may be made automatically. For example, these adjustments to the fluids (e.g., fluids 42 and 44) transmitted to the resonator 14 may be made automatically in response to a schedule. That is, the adjustments may be made, for example, every hour, every six hours, every day, every week, every month, etc. Additionally or alternatively, the adjustments may be made via a user request. That is, a user may request at a given time that the controller 38 read the measurements from the sensor and adjust the valves 78 and 80 accordingly. In this manner, the overall oscillations in the combustor 20 may be reduced in real time, that is, in response to events as they occur.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a resonator configured to dampen oscillations; and
a resonator control system configured to provide a ratio of a first fluid and a second fluid into the resonator to control a resonance characteristic of the resonator, wherein the first fluid is different than the second fluid.

2. The system of claim 1, wherein the resonance characteristic comprises a resonance frequency of the resonator.

3. The system of claim 1, wherein the resonator comprises a first fluid inlet configured to receive the first fluid, a second fluid inlet configured to receive the second fluid, and at least one outlet coupled to a chamber having the oscillations.

4. The system of claim 3, wherein the chamber comprises a combustion chamber.

5. The system of claim 1, wherein the resonator control system comprises a sensor configured to provide feedback indicative of the oscillations, and a controller configured to adjust the ratio of the first and second fluids in response to the feedback.

6. The system of claim 5, wherein the resonator control system comprises a first flow controller coupled to the controller, and the controller is configured to control the first flow controller to adjust a first flow rate of the first fluid into the resonator.

7. The system of claim 6, wherein the resonator control system comprises a second flow controller coupled to the controller, and the controller is configured to control the second flow controller to adjust a second flow rate of the second fluid into the resonator.

8. The system of claim 1, wherein the resonator control system is configured to fix a first flow rate of the first fluid and a second flow rate of the second fluid in the ratio.

9. A system, comprising:
a resonator controller configured to adjust a ratio of a first fluid and a second fluid into a resonator, the first fluid is different than the second fluid, and the resonator controller is configured to control a resonance frequency of the resonator to dampen oscillations based on the ratio.

10. The system of claim 9, comprising a sensor configured to provide feedback indicative of the oscillations, wherein the resonator controller is configured to adjust the ratio of the first and second fluids in response to the feedback.

11. The system of claim 10, comprising a first flow controller coupled to the resonator controller, and the resonator controller is configured to control the first flow controller to adjust a first flow rate of the first fluid into the resonator.

12. The system of claim 11, comprising a second flow controller coupled to the resonator controller, and the resonator controller is configured to control the second flow controller to adjust a second flow rate of the second fluid into the resonator.

13. The system of claim 9, wherein the resontator controller is configured to adjust the ratio between a first ratio and a second ratio, the first ratio includes only the first fluid, and the second ratio includes only the second fluid.

14. The system of claim 9, wherein a molecular weight or a specific heat ratio of the first fluid is at least greater than 10 percent different than the second fluid.

15. The system of claim 9, wherein a molecular weight of the first fluid is at least greater than 50 percent different than the second fluid.

16. The system of claim 9, wherein the first fluid comprises a vapor and the second fluid comprises a gas.

17. A system, comprising:
an engine comprising a combustion chamber; and
a resonator coupled to the combustion chamber, wherein the resontator is configured to dampen oscillations in the combustion chamber, the resontator is configured to receive a first fluid and a second fluid in a ratio to control a resonance frequency of the resonator, and the first fluid is different than the second fluid.

18. The system of claim 17, wherein the resonator comprises an annular chamber configured to surround the combustion chamber.

19. The system of claim 17, wherein the resonator comprises a Helmholtz resonator or a quarter wave resonator.

20. The system of claim 17, wherein the resonator is configured to receive the first fluid and the second fluid through at least one fluid inlet and transmit the first fluid and second fluid into the combustion chamber through at least one fluid outlet in response to pressure oscillations in the combustion chamber.
